(19) United States
(12) Patent Application Publication
(10) Pub. No.: US 2021/0170453 A1
(43) Pub. Date: Jun. 10, 2021

(54) SELF-CONTAINED PRESSURE WASHER

(71) Applicant: Koblenz Electrica, S.A. de C.V., Cuautitlan Izcalli (MX)

(72) Inventors: Richard Arthur Kohler Fernandez, Cuautitlan Izcalli (MX); Marco Antonio Cortes Ruiz, Cuautitlan Izcalli (MX); Andres Alfredo Vega Yanez, Cuautitlan Izcalli (MX); Luis Daniel Mosqueda Silva, Cuautitlan Izcalli (MX)

(21) Appl. No.: 17/025,581

(22) Filed: Sep. 18, 2020

Related U.S. Application Data
(60) Provisional application No. 62/902,072, filed on Sep. 18, 2019.

(51) Int. Cl. B08B 3/02; F04B 1/145; F04B 9/04; F04B 17/06; F04B 17/03; F04B 53/16; F04B 53/14

(52) U.S. Cl. CPC B08B 3/026; F04B 1/145; F04B 9/045; F04B 53/14; F04B 17/03; F04B 53/16; F04B 17/06

(57) ABSTRACT

A device includes a tank configured to contain a quantity of water; a pump configured to extract water from the tank and to pressurize the water; a connector in fluid communication with the tank and coupled to the tank so as to receive pressurized water produced by the tank and convey the pressurized water through the connector; and a plurality of lances configured to be interchangeably coupled to the connector to receive the pressurized water from the connector and to expel the water, wherein the plurality of lances includes a fog lance including a fog nozzle having an aperture that is sized from 0.35 mm to 0.45 mm, wherein the fog nozzle (a) includes a fog piston configured to cause rotational movement of water passing therethrough, (b) produces a flow rate of less than 0.17 liters per minute, and (c) produces an output that travels at least 1 meter.

### CROSS-REFERENCE TO RELATED APPLICATION

This application is a Section 111(a) application relating to and claiming the benefit of commonly-owned, co-pending U.S. Provisional patent application No. 62/902,072, entitled “SELF-CONTAINED PRESSURE WASHER,” filed on Sep. 18, 2019, the contents of which are incorporated herein by reference in their entirety.

### BACKGROUND

### 1. Field of the Invention

The present invention relates to a method, system, and/or apparatus pressure washing. More particularly, the present invention relates to a method, system, and/or apparatus for pressure washing using a self-contained fluid system.

### 2. Description of the Related Art

Pressure washing conventionally involves the use of a high-velocity and/or pressure flow of water against a surface in order to clean or otherwise remove substances (e.g., paint, dirt, etc.) from the surface. Any of a variety of surfaces can benefit from pressure washing, such as via the removal of paint or other particulates from concrete, removal of dirt or mud from fencing or other building surfaces, and removal of road grime, salt, or other elements from vehicle exteriors. Not only has conventional pressure washing made cleaning easier and most convenient than traditional washing of surfaces without the high pressure flow of fluid that has been used, pressure washing can also aid in conservation of fluid, such as water, by using a lower volume of water than would otherwise be used to clean surfaces. However, conventional pressure washing systems can pose some problems or inconveniences to consumers, either via expensive pricing, inconvenient transport or use, and/or inadequate time that such systems may be used before running out of power and/or fluid, forcing the user to wait until the system is ready for use again. An improved pressure washing method, system, and apparatus would address the above, and other problems, by providing a convenient, inexpensive, and efficient pressure washer.

### SUMMARY

The present invention is related to a method, system, and apparatus for pressure washing. In one embodiment, a pressure washer may include a tank configured to contain a volume of water, the tank having an opening therein for provision of water into the tank, a first filter disposed within the opening for filtering of water being provided into the tank for providing a first level of filtration to water associated with the tank, a second filter for providing a second level of filtration to water associated with the tank, a pump for pressurizing at least a portion of the volume of water from the tank, and a spray device, in communication with the pump, for outputting the pressurized portion of the volume of water.

In another embodiment, a method for providing pressurized fluid may include providing a tank configured to contain a volume of water, the tank having an opening therein for provision of water into the tank, providing a first filter disposed within the opening for filtering of water being provided into the tank for providing a first level of filtration to water associated with the tank, providing a second filter for providing a second level of filtration to water associated with the tank, providing a pump for pressurizing at least a portion of the volume of water from the tank, providing a spray device, in communication with the pump, for outputting the pressurized portion of the volume of water, receiving water into the tank, filtering at least a portion of the water using the first filter and the second filter, pressurizing at least a portion of the water using the pump, and outputting the pressurized water using the spray device.

In some embodiments, a device includes a tank sized and shaped to contain a quantity of water, wherein the quantity of water is between 4 gallons and 12 gallons; a pump in fluid communication with the tank, wherein the pump is configured to extract water from the tank and to pressurize the water extracted from the tank to a pressure that is from 500 psi to 1500 psi, wherein the pump has an electrical current of between 8 A and 10 A and a power of between 960 W and 1200 W; a connector having a first end and a second end, wherein the first end of the connector is in fluid communication with the tank and is coupled to the tank so as to receive pressurized water produced by the tank and convey the pressurized water through the connector from the first end to the second end; and a plurality of lances configured to be interchangeably coupled to the second end of the connector so as to receive the pressurized water from the second end of the connector and to expel the water, wherein the plurality of lances includes a first lance that is a fog lance, wherein the fog lance has a fog nozzle, wherein the fog nozzle includes a fog nozzle lid having an aperture having a size that is from 0.35 mm to 0.45 mm, wherein the fog nozzle includes a fog piston configured to cause rotational movement of water passing therethrough, wherein the fog nozzle is configured to produce a fog nozzle flow rate that is less than 0.17 liters per minute, and wherein the fog nozzle is configured to produce a fog output that travels at least 1 meter from the fog nozzle.

In some embodiments, the tank is sufficiently sized such that the quantity of water is a sufficient quantity of water to allow for continuous use at the fog nozzle flow rate for a duration of at least three hours.

In some embodiments, the fog nozzle is configured to produce a fog output having an average droplet size of about 20 microns.

In some embodiments, the device also includes a battery.

In some embodiments, the device also includes a power cable configured to be coupled to an external power source.

In some embodiments, the device also includes one or more wheels configured to allow the device to be rolled.

In some embodiments, the device also includes a container, wherein the container is configured to hold a cleaning product, wherein the container is positioned in fluid communication with the tank and the connector between the tank and the first end of the connector, and wherein the container is configured such that the cleaning product mixes with water passing from the tank to the connector. In some embodiments, the cleaning product is a disinfectant.

In some embodiments, the pump and the fog nozzle cooperate to produce the fog output without a supply of pressurized air.

In some embodiments, the plurality of lances includes a second lance that is a pressure washing lance. In some embodiments, the pressure washing lance is configured to output water at a flow rate of about 5 liters per minute. In some embodiments, the pressure washing lance is configured to output water at a working pressure of about 800 psi. In some embodiments, the pressure washing lance includes a nozzle regulator that is operable by a user to adjust a spray pattern of water output by the pressure washing lance.

In some embodiments, the plurality of lances includes a second lance that is a misting lance. In some embodiments, the misting lance has a misting nozzle, wherein the misting nozzle includes a misting nozzle lid having an aperture having a size that is from 0.35 mm to 0.45 mm, wherein the misting nozzle is configured to produce a misting nozzle flow rate that is greater than 0.17 liters per minute, and wherein the misting nozzle is configured to produce a mist output that travels at least 1 meter from the misting nozzle. In some embodiments, the misting nozzle is configured to produce a misting nozzle flow rate that is about 450 milliliters per minute. In some embodiments, the misting nozzle is configured to produce a mist output having an average droplet size that is in a range of from 20 to 40 microns.

### BRIEF DESCRIPTION OF THE DRAWINGS

The features, objects, and advantages of the present invention will become more apparent from the detailed description set forth below when taken in conjunction with the drawings, wherein:

FIG. 1A shows a front perspective view of a self-contained pressure washer, according to one embodiment of the present invention;

FIG. 1B shows a rear perspective view of the self-contained pressure washer of FIG. 1A, according to one embodiment of the present invention;

FIG. 1C shows a front view of the self-contained pressure washer of FIG. 1A, according to one embodiment of the present invention;

FIG. 1D shows a rear view of the self-contained pressure washer of FIG. 1A, according to one embodiment of the present invention;

FIG. 1E shows a side view of the self-contained pressure washer of FIG. 1A, according to one embodiment of the present invention;

FIG. 1F shows a top view of the self-contained pressure washer of FIG. 1A, according to one embodiment of the present invention;

FIG. 2 shows an expanded perspective view of a self-contained pressure washer, according to one embodiment of the present invention;

FIG. 3A shows an exploded view of an exemplary pressure washing lance;

FIG. 3B shows a section view of a portion of the exemplary pressure washing lance shown in FIG. 3A;

FIG. 3C shows a first pressure washing output produced by the exemplary pressure washing lance shown in FIG. 3A;

FIG. 3D shows a second pressure washing output produced by the exemplary pressure washing lance shown in FIG. 3A;

FIG. 4A shows an exploded view of an exemplary misting lance;

FIG. 4B shows a magnified exploded view of certain elements of the exemplary misting lance shown in FIG. 4A;

FIG. 4C shows a section view of a portion of the exemplary misting lance shown in FIG. 4A;

FIG. 4D shows a mist output produced by the exemplary misting lance shown in FIG. 4A;

FIG. 5A shows an exploded view of an exemplary fog lance;

FIG. 5B shows a magnified exploded view of certain elements of the exemplary fog lance shown in FIG. 5A;

FIG. 5C shows a fog piston of the exemplary fog lance shown in FIG. 5A;

FIG. 5D shows a section view of a portion of the exemplary fog lance shown in FIG. 5A; and

FIG. 5E shows a fog output produced by the exemplary fog lance shown in FIG. 5A.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

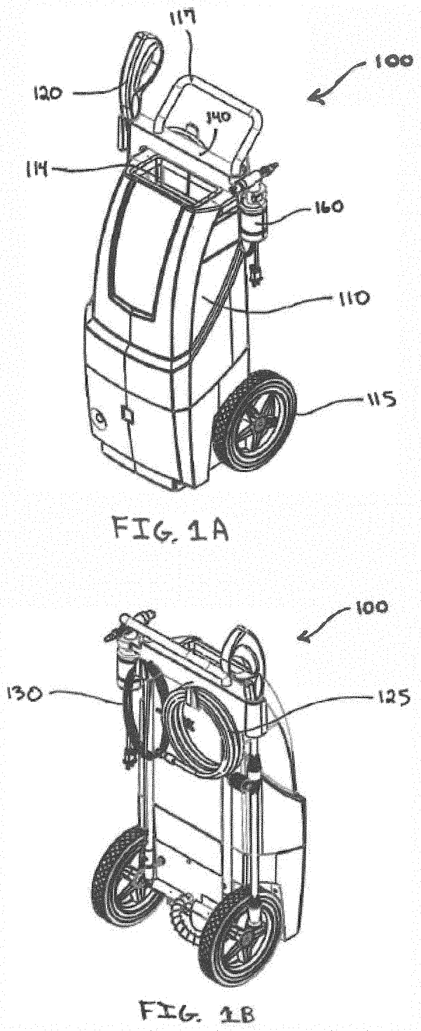

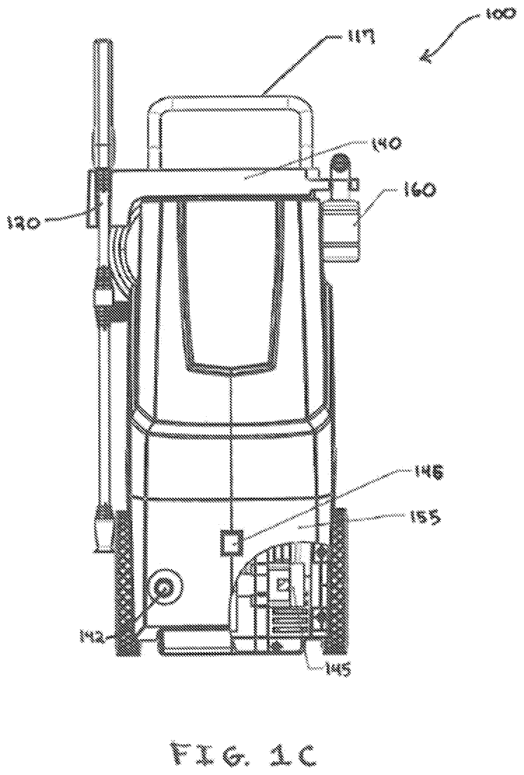

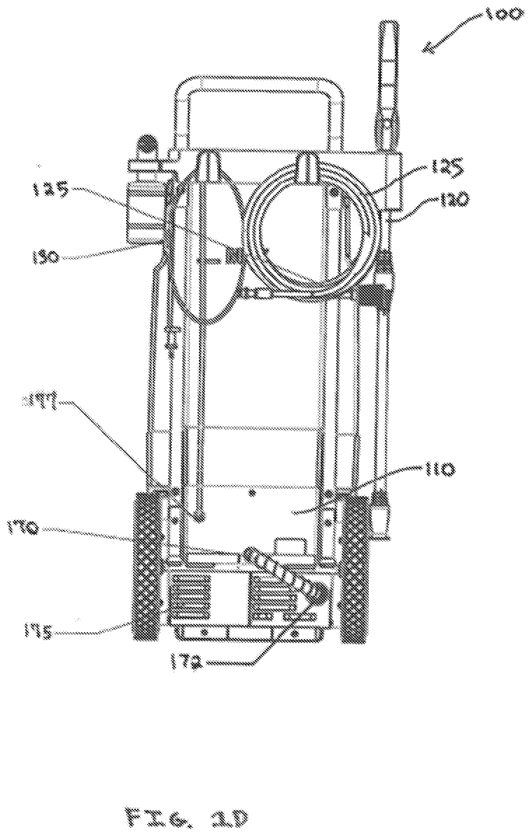

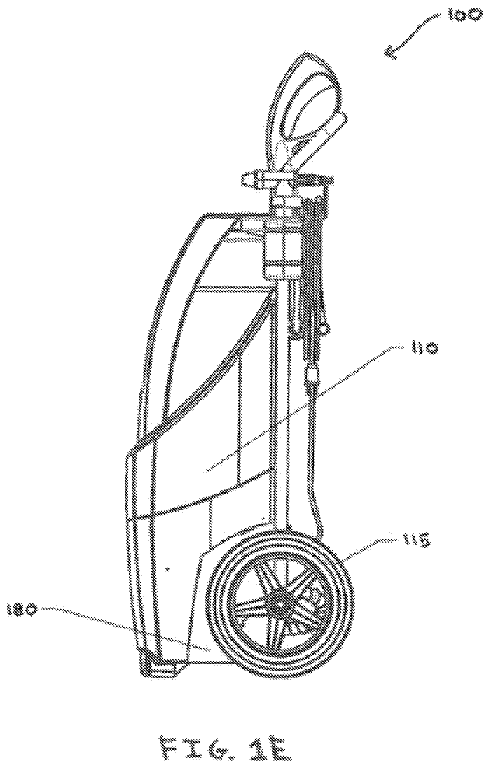

With respect to FIG. 1A a front perspective view of a self-contained pressure washer 100 is illustrated. The pressure washer 100 includes a fluid (e.g., water) tank 110 that is configured to hold a volume of fluid for use. The tank 110 may be detachable or not detachable in alternative embodiments. In one embodiment, the tank 110 may be fully and/or partially transparent or translucent, for example, to allow a user to verify fluid level within the tank 110. Any of a variety of possible fluids and/or fluid volumes (e.g., 8-gallon) may be configured to be contained within the tank 110 in certain embodiments. The tank 110 may be configured to be filled via an opening of the pressure washer 100 that permits a user to provide water into the tank 110. In such a system, a user is not required to have any access to a nearby water source (such as a hose, faucet, etc.). To use the pressure washer 100 since a quantity of water can be stored or contained within the pressure washer 100 itself. In certain embodiments, the pressure washer 100 may be configured to draw fluid from the tank 110 for use, as discussed in greater detail below and/or, in an alternative embodiment, be configured to use fluid being presently provided from an outside source (e.g., a hose, faucet, etc.) for use. In such an embodiment, the pressure washer 100 may be capable of use in both a location where no exterior source of fluid is available and in a location where an exterior source of fluid is available in order to allow for longer duration of use of the pressure washer 100 without requiring extended storage of water in the tank prior to its use. For example, the pressure washer 100 may be immediately used, such as without requiring an external fluid source deliver any minimum input fluid pressure (e.g., kPA) and/or fluid volume within the tank 110 before operation may commence.

In some embodiments, the tank 110 is sized to contain 8 gallons of water. In some embodiments, the tank 110 is sized to contain between 7 gallons and 9 gallons of water. In some embodiments, the tank is sized to contain between 6 gallons and 10 gallons of water. In some embodiments, the tank is sized to contain between 5 gallons and 11 gallons of water. In some embodiments, the tank is sized to contain between 4 gallons and 12 gallons of water.

A filter 114 (e.g., for helping in preventing undesired particulates or other elements from entering the tank 110) may be provided and fit within the opening. The pressure washer 100 includes a transportation system or element(s) 115 (e.g., one or more wheels) that allow the pressure washer 100 to be conveniently transported (e.g., rolled) among different locations. For example, a bar or other holding element 117 may allow for a user to grasp or otherwise maintain control of effectuating movement of the pressure washer 100, for example, via the transportation system or element(s) 115.

A spray device 120 is in fluid communication with the tank 110 such that fluid from the tank 110 may flow (e.g., a pressurized flow) out of the spray device 120 and be directed at desired surfaces by a user of the pressure washer 100. The spray device 120 may take any of a variety of possible forms, such as a gun or pole having a triggering element that can be manipulated (e.g., pressed or squeezed) by a user to start a spray of fluid from an opening of the spray device 120. The spray device 120 may be connected with the tank 110 through one or more additional elements, such as a bottle or container 160, that may, for example, be configured to hold a cleaning product such as shampoo or other chemicals (e.g., a disinfectant) for mixture with pressurized fluid from the tank 110 prior to transmittal out of the spray device 120, as discussed in greater detail herein.

A holding element 140 may be included as part of the pressure washer 100. For example, the holding element 140 may be a removable tray, bar, or other connector or surface that is configured to allow for storage or placement of devices, such as tools, brushes, nozzles, etc. therein. In this fashion, a user of the pressure washer 100 may conveniently carry tools or other elements that may be needed or desired while pressure washing and have such tools or other elements conveniently available and within reach. In another embodiment, the holding element 140 may be a depression or other surface that is manufactured (e.g., molded) as part of a panel or body component of the pressure washer 100.

FIG. 1B shows a rear perspective view of the self-contained pressure washer 100. With reference to prior figure(s) and the previous discussion, as shown, the pressure washer 100 includes a hose (e.g., a high pressure hose) 125 that facilitates a flow of pressurized fluid that originates in the tank 110 and eventually flows to the spray device 120, as discussed in greater detail herein In order to properly pressurize fluid (e.g., 800 psi) from the tank 110, as discussed in greater detail here, the pressure washer 100 uses power obtained via a power cable 130 (e.g., 35 feet) connected with its associated electrical and/or mechanical components. The power cable 130 may be configured to receive and/or conduct power from any of a variety of sources (e.g., standard power outlet, car outlet, etc.) In one embodiment, the pressure washer 100 may run its electrical and/or mechanical components directly off of power received via the power cable 130 (e.g., immediate and/or continuous use while plugged in). In an alternative embodiment, the pressure washer 100 may include one or more batteries that store a charge via power received via the power cable 130. In still another embodiment, the pressure washer 100 may be capable of both direct power use and/or battery charge storage.

FIG. 1C shows a front view of the self-contained pressure washer 100. With reference to prior figure(s) and the previous discussion, as shown, the pressure washer 100 includes electrical/mechanical components, such as a motor/pump 145 for pressurizing fluid, for example, that originates in the tank 110 for eventual transmittal to the spray device 120 via the hose 125. An outlet 142 may be provided for providing fluid from the tank 110, after the fluid has been pressurized by the motor/pump 145 to the hose 125 for transmission to the spray device 120. As previously discussed, the bottle or container 160 may be configured to connect at some position between the spray device 120 and the outlet 142, for example, in line with the hose 125 so that pressurized fluid passes through the bottle or container 160, thereby mixing with shampoo or other chemicals contained within the bottle or container 160 prior to the fluid exiting the spray device 120. In certain embodiments, no bottle or container 160 may be used and the spray device 120 may be configured to connect directly with the outlet 142 or other element(s) in order to be in fluid communication with the tank 110.

In some embodiments, the motor/pump 145 has a voltage of between 60 V and 180 V. In some embodiments, the motor/pump 145 has a voltage of between 60 V and 160 V. In some embodiments, the motor/pump 145 has a voltage of between 60 V and 140 V. In some embodiments, the motor/pump 145 has a voltage of between 60 V and 120 V. In some embodiments, the motor/pump 145 has a voltage of between 60 V and 100 V. In some embodiments, the motor/pump 145 has a voltage of between 60 V and 80 V. In some embodiments, the motor/pump 145 has a voltage of between 80 V and 180 V. In some embodiments, the motor/pump 145 has a voltage of between 80 V and 160 V. In some embodiments, the motor/pump 145 has a voltage of between 80 V and 140 V. In some embodiments, the motor/pump 145 has a voltage of between 80 V and 120 V. In some embodiments, the motor/pump 145 has a voltage of between 80 V and 100 V. In some embodiments, the motor/pump 145 has a voltage of between 100 V and 180 V. In some embodiments, the motor/pump 145 has a voltage of between 100 V and 160 V. In some embodiments, the motor/pump 145 has a voltage of between 100 V and 140 V. In some embodiments, the motor/pump 145 has a voltage of between 100 V and 120 V. In some embodiments, the motor/pump 145 has a voltage of between 120 V and 180 V. In some embodiments, the motor/pump 145 has a voltage of between 120 V and 160 V. In some embodiments, the motor/pump 145 has a voltage of between 120 V and 140 V. In some embodiments, the motor/pump 145 has a voltage of between 140 V and 180 V. In some embodiments, the motor/pump 145 has a voltage of between 140 V and 160 V. In some embodiments, the motor/pump 145 has a voltage of between 160 V and 180 V. In some embodiments, the motor/pump 145 has a voltage of between 105 V and 135 V. In some embodiments, the motor/pump 145 has a voltage of between 110 V and 120 V. In some embodiments, the motor/pump 145 has a voltage of between 115 V and 125 V. In some embodiments, the motor/pump 145 has a voltage of about 120 V. In some embodiments, the motor/pump 145 has a voltage of 120 V.

In some embodiments, the motor/pump 145 has a current of 9 A. In some embodiments, the motor/pump 145 has a current of between 8 A and 10 A. In some embodiments, the motor/pump 145 has a current of between 7 A and 11 A. In some embodiments, the motor/pump 145 has a voltage of 120 V, a current of 9 A, and a power of 1080 W. In some embodiments, the motor/pump 145 has a voltage of 120 V, a current of between 8 A and 10 A, and a power of between 960 W and 1200 W. In some embodiments, the motor/pump 145 is operable to produce a water pressure that is between 500 psi and 1500 psi. In some embodiments, the motor/pump 145 has a voltage of 120V and a current of 9 A, and is operable to produce a water pressure that is between 500 psi and 1500 psi. In some embodiments, the motor/pump 145 has a voltage of 120V and a current of between 8 A and 10 A, and is operable to produce a water pressure that is between 500 psi and 1500 psi.

In order to turn on and/or supply power to the motor/pump 145, a user control 146 (e.g., a switch, button, etc.) is provided on a front enclosure or panel 155 of the pressure washer 100. Although the various components discussed are illustrated and/or discussed as having particular locations on the pressure washer 100, an alternative embodiment may locate one or more of the various elements discussed in alternative locations (e.g., the user control 146 may be disposed adjacent to the holding element 117). In certain embodiments, no user control 146 may be used (e.g., the motor/pump 145 may turn on without further user intervention upon supplying power, for example, upon plugging the power cable 130 into a suitable power source).

FIG. 1D shows a rear view of the self-contained pressure washer 100. With reference to prior figure(s) and the previous discussion, as shown, the pressure washer 100 includes the tank 110 that provides fluid from the tank 110 to the motor/pump 145 via a fluid hose 170 that connects the tank 110 to a fluid inlet 172 of the motor/pump 145. Accordingly, in one embodiment during use, the pressure washer 100 is configured to take fluid (e.g., non-pressurized) from the tank 110 and supply it through the motor/pump 145 for pressurizing the fluid, and transmitting the pressurized fluid to the spray device 120 via the hose 125. The motor/pump 145 and/or other electrical/mechanical components associated with the pressure washer 100 may use heat dissipation or cooling features, such as heatsinks, cooling slots 175, etc. in order to keep temperatures of the electrical mechanical components a desired level to aid in proper operation. FIG. 1D also illustrates a strain relief 177 connected with or otherwise associated with the power cable 130, for example, to aid in preventing damage to the power cable 130 and/or its connected components if the power washer 100 is moved or positioned at a distance from a power source that causes tugging or pulling on the power cable 130.

FIG. 1E shows a side view of the self-contained pressure washer 100. With reference to prior figure(s) and the previous discussion, as shown, the pressure washer 100 may include an enclosure 180 that is completely and/or partially removable and configured to contain all or some of the electrical/mechanical components previously discussed, such as the motor/pump 145. For example, the enclosure 180 may have one or more panels that may be removed in order to provide access to the electrical/mechanical components positioned therein. Such removability of the enclosure 180 and/or of elements of the enclosure 180 (e.g., one or more panels or surfaces making up the enclosure 180) may permit repair or replacement access should one or more of the electrical/mechanical components require servicing.

FIG. 1F shows a top view of the self-contained pressure washer 100. With reference to prior figure(s) and the previous discussion, as shown, the pressure washer 100 may include a filter 190 for filtering the fluid being transmitted from the tank 110 prior to the fluid being flowed out of the spray device 120. The filter 190 may be configured to filter all or some of the fluid from the tank. In certain embodiments, a second filter, such as a filter configured to engage with fluid after it has already passed through the filter 190, may be provided with the pressure washer 100 in order to include dual-stage filtering. The second filter may be included adjacent to the filter 190, and/or at any of a variety of other locations (e.g., within the tank 110, between the tank 110 and the motor/pump 145, between the motor/pump 145 and the spray device 120, etc. Indeed, any of a variety of possible filtration components and/or locations may be used in various embodiments. The pressure washer 100 may also include any of a variety of possible dimensions, such as a total width 195 of 18-19 inches.

In some embodiments, the flow rate of fluid from the tank 110 to the spray device 120 (e.g., the rate of water consumption of the pressure washer 100) is between 1 liter per minute (L/m) and 9 L/m. In some embodiments, the flow rate is between 1 L/m and 8 L/m. In some embodiments, the flow rate is between 1 L/m and 7 L/m. In some embodiments, the flow rate is between 1 L/m and 6 L/m. In some embodiments, the flow rate is between 1 L/m and 5 L/m. In some embodiments, the flow rate is between 1 L/m and 4 L/m. In some embodiments, the flow rate is between 1 L/m and 3 L/m. In some embodiments, the flow rate is between 1 L/m and 2 L/m. In some embodiments, the flow rate is between 2 L/m and 9 L/m. In some embodiments, the flow rate is between 2 L/m and 8 L/m. In some embodiments, the flow rate is between 2 L/m and 7 L/m. In some embodiments, the flow rate is between 2 L/m and 6 L/m. In some embodiments, the flow rate is between 2 L/m and 5 L/m. In some embodiments, the flow rate is between 2 L/m and 4 L/m. In some embodiments, the flow rate is between 2 L/m and 3 L/m. In some embodiments, the flow rate is between 3 L/m and 9 L/m. In some embodiments, the flow rate is between 3 L/m and 8 L/m. In some embodiments, the flow rate is between 3 L/m and 7 L/m. In some embodiments, the flow rate is between 3 L/m and 6 L/m. In some embodiments, the flow rate is between 3 L/m and 5 L/m. In some embodiments, the flow rate is between 3 L/m and 4 L/m. In some embodiments, the flow rate is between 4 L/m and 9 L/m. In some embodiments, the flow rate is between 4 L/m and 8 L/m. In some embodiments, the flow rate is between 4 L/m and 7 L/m. In some embodiments, the flow rate is between 4 L/m and 6 L/m. In some embodiments, the flow rate is between 4 L/m and 5 L/m. In some embodiments, the flow rate is between 5 L/m and 9 L/m. In some embodiments, the flow rate is between 5 L/m and 8 L/m. In some embodiments, the flow rate is between 5 L/m and 7 L/m. In some embodiments, the flow rate is between 5 L/m and 6 L/m. In some embodiments, the flow rate is between 6 L/m and 9 L/m. In some embodiments, the flow rate is between 6 L/m and 8 L/m. In some embodiments, the flow rate is between 6 L/m and 7 L/m. In some embodiments, the flow rate is between 7 L/m and 9 L/m. In some embodiments, the flow rate is between 7 L/m and 8 L/m. In some embodiments, the flow rate is between 8 L/m and 9 L/m. In some embodiments, the flow rate is between 3.5 L/m and 6.5 L/m. In some embodiments, the flow rate is between 4.5 L/m and 5.5 L/m. In some embodiments, the flow rate is about 5 L/m. In some embodiments, the flow rate is 5 L/m.

In some embodiments, the pressure of the fluid delivered by the pressure washer 100 is between 400 psi and 1200 psi. In some embodiments, the pressure of the fluid delivered by the pressure washer 100 is between 400 psi and 1000 psi. In some embodiments, the pressure of the fluid delivered by the pressure washer 100 is between 400 psi and 800 psi. In some embodiments, the pressure of the fluid delivered by the pressure washer 100 is between 400 psi and 600 psi. In some embodiments, the pressure of the fluid delivered by the pressure washer 100 is between 600 psi and 1200 psi. In some embodiments, the pressure of the fluid delivered by the pressure washer 100 is between 600 psi and 1000 psi. In some embodiments, the pressure of the fluid delivered by the pressure washer 100 is between 600 psi and 800 psi. In some embodiments, the pressure of the fluid delivered by the pressure washer 100 is between 800 psi and 1200 psi. In some embodiments, the pressure of the fluid delivered by the pressure washer 100 is between 800 psi and 1000 psi. In some embodiments, the pressure of the fluid delivered by the pressure washer 100 is between 1000 psi and 1200 psi. In some embodiments, the pressure of the fluid delivered by the pressure washer 100 is between 650 psi and 950 psi. In some embodiments, the pressure of the fluid delivered by the pressure washer 100 is between 700 psi and 900 psi. In some embodiments, the pressure of the fluid delivered by the pressure washer 100 is between 750 psi and 850 psi. In some embodiments, the pressure of the fluid delivered by the pressure washer 100 is between 775 psi and 825 psi. In some embodiments, the pressure of the fluid delivered by the pressure washer 100 is about 800 psi. In some embodiments, the pressure of the fluid delivered by the pressure washer 100 is 800 psi.

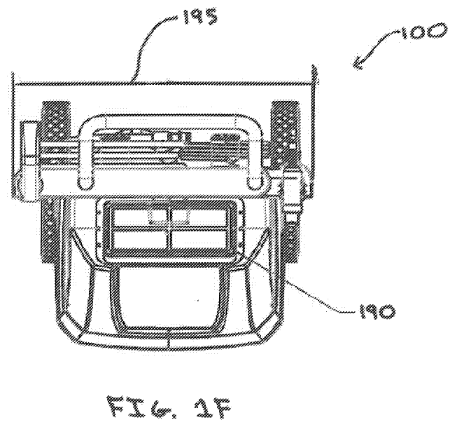

FIG. 2 shows an expanded perspective view of a self-contained pressure washer 200. The pressure washer 200 may include certain features that are the same as or similar to those previously discussed. Various of the pressure washer 200 components, as discussed in greater detail below, may be manufactured of lightweight and/or engineered plastics in one embodiment. As illustrated, the pressure washer 200 may include a tank 210 (e.g., a water-proof tank) that is configured to hold a volume of fluid, such as water, therein. The tank 210 may be formed of a single component or material (e.g., molded plastic) that contains a cavity therein. In an alternative embodiment, the tank 210 may be formed of a plurality of panels or surfaces that are connected together to form a hollow interior within the plurality of panels or surfaces so as to contain fluid, such as water, therein. A fill hole, or other connection and/or opening 212 may be provided to allow fluid to be disposed (e.g., from a hose) into the tank 210. One or more labels or other elements (211, 213) may be configured to be applied to the tank 210 giving additional information concerning the tank 210 and/or its operation (e.g., permitted fluids, maximum and/or minimum fluid volume for use, instructions for use or start of electrical/mechanical components connected with or associated with the tank, etc.)

FIG. 2 also illustrates a holding component (e.g., a tray) 240 that may be configured to hold and/or contain tools or other objects, such as connectors or adapters associated with the pressure washer 100 and/or other objects, the same or similar to previous discussions. A filter (e.g., a fluid filter) 214 may be configured to be accepted within an opening of the pressure washer 100, for example, to be at least partially received in the opening 212. The fluid filter 214 may be configured to be removable from the opening 212 and/or may be configured to be permanently affixed in place but still allow for fluid to flow there through (e.g., through use of slots, mesh, etc.). In such a fashion, the fluid filter 214 may be configured to allow for the tank 210 to be filled with fluid (e.g., by pouring fluid into the fluid filter 214 and thereby exiting the fluid filter 214 and through the opening 212 into the tank 210. The filter may help in preventing undesired particulates from entering the tank 210 and potentially interfering with operation of the pressure washer 100.

A handle or other maneuvering component 217 may be connected with the tank 210 to permit user movement of the pressure washer 100, for example, via one or more locomotion elements (215, 216), such as wheels as illustrated (e.g., having diameter(s) of greater or less than those explicitly shown (such as 10 inches) in the exemplary FIG. 1 illustration). The locomotion elements (215, 216) may be connected via a rod or other connector 213 in certain embodiments. In an alternative embodiment, greater or fewer wheels, or alternative and/or fewer and/or additional locomotion elements may be used.

A motor and/or pump, and associated electrical and/or mechanical components 245, such as cabling, cooling elements, etc. is at least partially contained within a lower enclosure 257 (e.g., constructed of a front panel 255 and a rear panel 256). In an alternative embodiment, other manufacturing techniques and/or methods may be used for forming the lower enclosure 257 (e.g., only one component comprising the entire enclosure and/or additional and/or alternative configurations of paneling, surfaces, or elements making up the exterior of the lower enclosure 257). The lower enclosure 257 may include a variety of possible cooling features or elements (e.g., powered or unpowered), such as slots, openings, fans, etc. for helping maintain the motor and/or pump, and associated electrical and/or mechanical components 245 at an acceptable operating temperature. For example, cooling openings 258 are illustrated and may allow airflow into the cavity of the lower enclosure 257 that at least partially contains the motor and/or pump and associated electrical and/or mechanical components 245. A power cable 230 and/or other or additional component (e.g., one or more batteries) may be provided for supplying power to the motor and/or pump, and associated electrical and/or mechanical components 245.

In some embodiments, the motor and/or pump and associated electrical and/or mechanical components 245 has a voltage of between 60 V and 180 V. In some embodiments, the motor and/or pump and associated electrical and/or mechanical components 245 has a voltage of between 60 V and 160 V. In some embodiments, the motor and/or pump and associated electrical and/or mechanical components 245 has a voltage of between 60 V and 140 V. In some embodiments, the motor and/or pump and associated electrical and/or mechanical components 245 has a voltage of between 60 V and 120 V. In some embodiments, the motor and/or pump and associated electrical and/or mechanical components 245 has a voltage of between 60 V and 100 V. In some embodiments, the motor and/or pump and associated electrical and/or mechanical components 245 has a voltage of between 60 V and 80 V. In some embodiments, the motor and/or pump and associated electrical and/or mechanical components 245 has a voltage of between 80 V and 180 V. In some embodiments, the motor and/or pump and associated electrical and/or mechanical components 245 has a voltage of between 80 V and 160 V. In some embodiments, the motor and/or pump and associated electrical and/or mechanical components 245 has a voltage of between 80 V and 140 V. In some embodiments, the motor and/or pump and associated electrical and/or mechanical components 245 has a voltage of between 80 V and 120 V. In some embodiments, the motor and/or pump and associated electrical and/or mechanical components 245 has a voltage of between 80 V and 100 V. In some embodiments, the motor and/or pump and associated electrical and/or mechanical components 245 has a voltage of between 100 V and 180 V. In some embodiments, the motor and/or pump and associated electrical and/or mechanical components 245 has a voltage of between 100 V and 160 V. In some embodiments, the motor and/or pump and associated electrical and/or mechanical components 245 has a voltage of between 100 V and 140 V. In some embodiments, the motor and/or pump and associated electrical and/or mechanical components 245 has a voltage of between 100 V and 120 V. In some embodiments, the motor and/or pump and associated electrical and/or mechanical components 245 has a voltage of between 120 V and 180 V. In some embodiments, the motor and/or pump and associated electrical and/or mechanical components 245 has a voltage of between 120 V and 160 V. In some embodiments, the motor and/or pump and associated electrical and/or mechanical components 245 has a voltage of between 120 V and 140 V. In some embodiments, the motor and/or pump and associated electrical and/or mechanical components 245 has a voltage of between 140 V and 180 V. In some embodiments, the motor and/or pump and associated electrical and/or mechanical components 245 has a voltage of between 140 V and 160 V. In some embodiments, the motor and/or pump and associated electrical and/or mechanical components 245 has a voltage of between 160 V and 180 V. In some embodiments, the motor and/or pump and associated electrical and/or mechanical components 245 has a voltage of between 105 V and 135 V. In some embodiments, the motor and/or pump and associated electrical and/or mechanical components 245 has a voltage of between 110 V and 120 V. In some embodiments, the motor and/or pump and associated electrical and/or mechanical components 245 has a voltage of between 115 V and 125 V. In some embodiments, the motor and/or pump and associated electrical and/or mechanical components 245 has a voltage of about 120 V. In some embodiments, the motor and/or pump and associated electrical and/or mechanical components 245 has a voltage of 120 V.

The motor and/or pump, and associated electrical and/or mechanical components 245 may be turned on via a user-interfaceable element (e.g., a button, switch, etc.) 246. In certain embodiments, the user-interfaceable element 246 may have a cover, label, or other means of information 249 disposed thereon or connected therewith (e.g., adhered to) to indicate to a user the operation that results from manipulation of the user-interfaceable element 246. When in operation, the motor and/or pump, and associated electrical and/or mechanical components 245 may operate to pressurize fluid from the tank 210 (e.g., received via an interconnecting conduit 270) and flow the pressurized fluid, via a hose (e.g., a pressurized hose) or other conduit 225 to a spray device 220. The same or similar to previous discussions, additional equipment or devices (e.g., one or more bottles or containers 260 containing cleaning fluid or other desired chemicals or particulates, such as disinfectant) to be added to the pressurized fluid) may be provided and/or connected in like with the flowing fluid prior to the fluid being expelled from the spray device 220.

In some embodiments, the flow rate of fluid from the tank 210 to the spray device 220 (e.g., the rate of water consumption of the pressure washer 200) is between 1 liter per minute (L/m) and 9 L/m. In some embodiments, the flow rate is between 1 L/m and 8 L/m. In some embodiments, the flow rate is between 1 L/m and 7 L/m. In some embodiments, the flow rate is between 1 L/m and 6 L/m. In some embodiments, the flow rate is between 1 L/m and 5 L/m. In some embodiments, the flow rate is between 1 L/m and 4 L/m. In some embodiments, the flow rate is between 1 L/m and 3 L/m. In some embodiments, the flow rate is between 1 L/m and 2 L/m. In some embodiments, the flow rate is between 2 L/m and 9 L/m. In some embodiments, the flow rate is between 2 L/m and 8 L/m. In some embodiments, the flow rate is between 2 L/m and 7 L/m. In some embodiments, the flow rate is between 2 L/m and 6 L/m. In some embodiments, the flow rate is between 2 L/m and 5 L/m. In some embodiments, the flow rate is between 2 L/m and 4 L/m. In some embodiments, the flow rate is between 2 L/m and 3 L/m. In some embodiments, the flow rate is between 3 L/m and 9 L/m. In some embodiments, the flow rate is between 3 L/m and 8 L/m. In some embodiments, the flow rate is between 3 L/m and 7 L/m. In some embodiments, the flow rate is between 3 L/m and 6 L/m. In some embodiments, the flow rate is between 3 L/m and 5 L/m. In some embodiments, the flow rate is between 3 L/m and 4 L/m. In some embodiments, the flow rate is between 4 L/m and 9 L/m. In some embodiments, the flow rate is between 4 L/m and 8 L/m. In some embodiments, the flow rate is between 4 L/m and 7 L/m. In some embodiments, the flow rate is between 4 L/m and 6 L/m. In some embodiments, the flow rate is between 4 L/m and 5 L/m. In some embodiments, the flow rate is between 5 L/m and 9 L/m. In some embodiments, the flow rate is between 5 L/m and 8 L/m. In some embodiments, the flow rate is between 5 L/m and 7 L/m. In some embodiments, the flow rate is between 5 L/m and 6 L/m. In some embodiments, the flow rate is between 6 L/m and 9 L/m. In some embodiments, the flow rate is between 6 L/m and 8 L/m. In some embodiments, the flow rate is between 6 L/m and 7 L/m. In some embodiments, the flow rate is between 7 L/m and 9 L/m. In some embodiments, the flow rate is between 7 L/m and 8 L/m. In some embodiments, the flow rate is between 8 L/m and 9 L/m. In some embodiments, the flow rate is between 3.5 L/m and 6.5 L/m. In some embodiments, the flow rate is between 4.5 L/m and 5.5 L/m. In some embodiments, the flow rate is about 5 L/m. In some embodiments, the flow rate is 5 L/m.

In some embodiments, the pressure of the fluid delivered by the pressure washer 200 is between 400 psi and 1200 psi. In some embodiments, the pressure of the fluid delivered by the pressure washer 200 is between 400 psi and 1000 psi. In some embodiments, the pressure of the fluid delivered by the pressure washer 200 is between 400 psi and 800 psi. In some embodiments, the pressure of the fluid delivered by the pressure washer 200 is between 400 psi and 600 psi. In some embodiments, the pressure of the fluid delivered by the pressure washer 200 is between 600 psi and 1200 psi. In some embodiments, the pressure of the fluid delivered by the pressure washer 200 is between 600 psi and 1000 psi. In some embodiments, the pressure of the fluid delivered by the pressure washer 200 is between 600 psi and 800 psi. In some embodiments, the pressure of the fluid delivered by the pressure washer 200 is between 800 psi and 1200 psi. In some embodiments, the pressure of the fluid delivered by the pressure washer 200 is between 800 psi and 1000 psi. In some embodiments, the pressure of the fluid delivered by the pressure washer 200 is between 1000 psi and 1200 psi. In some embodiments, the pressure of the fluid delivered by the pressure washer 200 is between 650 psi and 950 psi. In some embodiments, the pressure of the fluid delivered by the pressure washer 200 is between 700 psi and 900 psi. In some embodiments, the pressure of the fluid delivered by the pressure washer 200 is between 750 psi and 850 psi. In some embodiments, the pressure of the fluid delivered by the pressure washer 200 is between 775 psi and 825 psi. In some embodiments, the pressure of the fluid delivered by the pressure washer 200 is about 800 psi. In some embodiments, the pressure of the fluid delivered by the pressure washer 200 is 800 psi.

In one embodiment, the spray device 220 may include a handle/triggering component 221, a connecting rod or component 222 and an expelling rod or component 223. As pressurized fluid, such as water, is received at the spray device 220, e.g., from the hose 225, a user may manipulate a triggering element associated with the handle/triggering component 221 (e.g., a button, switch, trigger, etc.) that permits the pressurized fluid to transmit through the connecting rod or component 222. The pressurized fluid may exit the connecting rod or component 222 and travel through the further expelling rod or component 223 (e.g., to provide an extension for allowing a user to reach areas, such as high elevation surfaces, that might otherwise be difficult to reach). Any of a variety of possible adapters or components (e.g., spray nozzles, filters, containers for mixing with the pressurized fluid, such as the bottle or container 260) may be configured to connect with any or all of the handle/triggering component 221, the connecting rod or component 222 and/or the expelling rod or component 223. In this fashion, the spray device 220 may be customized by a particular user for a particular desired task, using a variety of possible attachments (e.g., by screwing, snapping, or otherwise adhering such attachments to one or more portions of the spray device 220. Various, screws, bolts, nuts, washer, clamps, grommets, etc. may be used as desired for securement or connection of parts.

In some embodiments, the pressure washer 200 includes a plurality of interchangeable types of the expelling rod or component 223 (which may alternately be referred to as interchangeable “lances”). In some embodiments, the pressure washer 200 includes one of the expelling rod or component 223 that is a pressure washing lance 300. In some embodiments, the pressure washer 200 includes one of the expelling rod or component 223 that is a misting lance 400. In some embodiments, the pressure washer 200 includes one of the expelling rod or component 223 that is a fog lance 500. In some embodiments, the pressure washer 200 includes two of, or all three of, the pressure washing lance 300, the misting lance 400, and the fog lance 500.

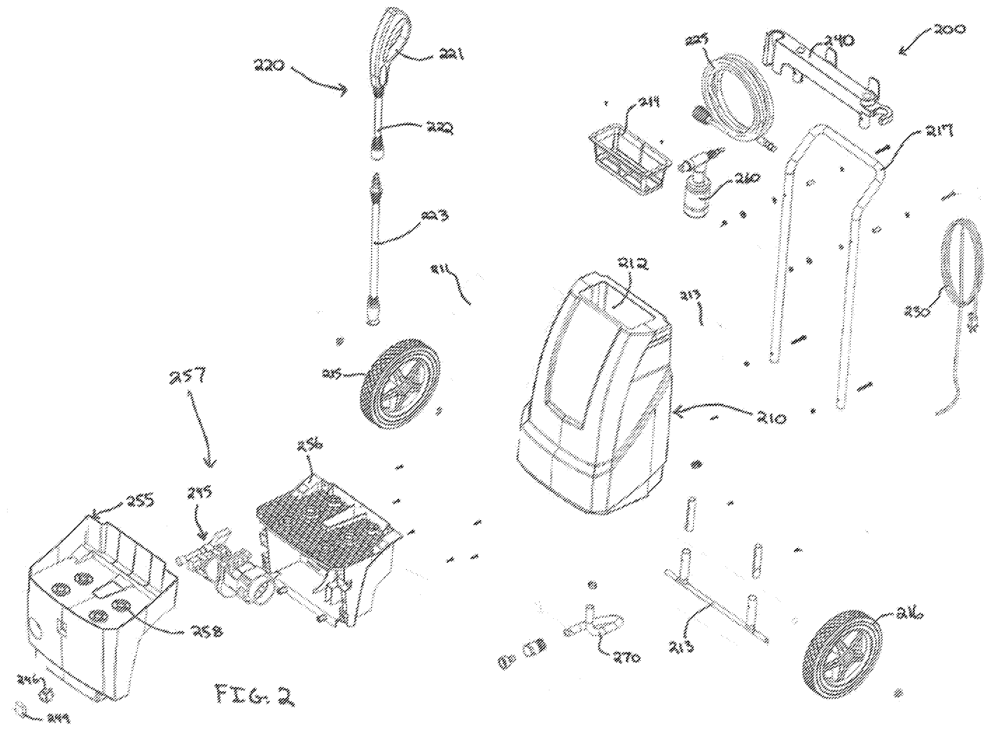

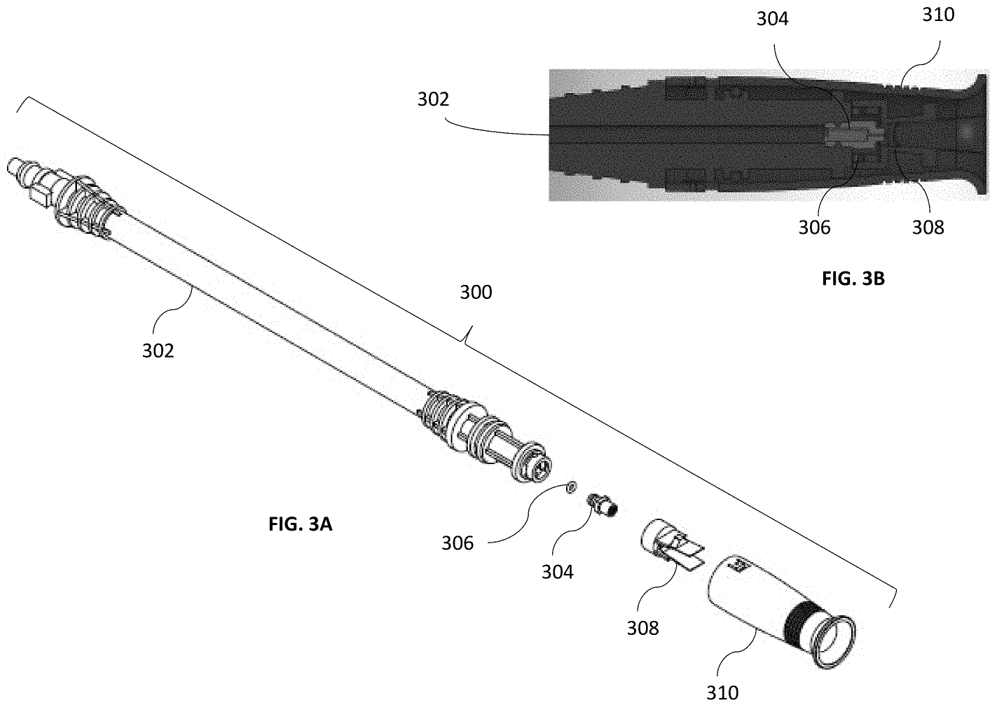

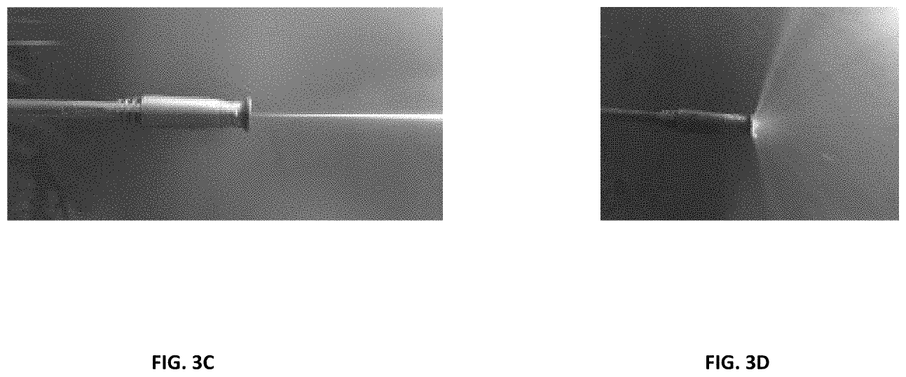

FIG. 3A shows an exploded view of an exemplary pressure washing lance 300 and FIG. 3B shows a section view of a head portion of the assembled pressure washing lance 300. In some embodiments, the pressure washing lance 300 includes a connector portion 302 that is configured to be coupled to the connecting rod or component 222 described above. In some embodiments, the pressure washing lance 300 includes a pressure washer nozzle 304 that is sized and shaped to output a supply of water provided along the connector portion 302 in a manner that is appropriate for pressure washing. In some embodiments, the pressure washing lance 300 includes an O-ring 306 providing sealing between the connector portion 302 and the pressure washer nozzle 304. In some embodiments, the pressure washing lance 300 includes a nozzle regulator 308. In some embodiments, the nozzle regulator 308 is operable to adjust a spray pattern output by the pressure washing lance 300. In some embodiments, the pressure washing lance 300 includes a lance cover 310 that is configured to connect to the connector portion 302 and to enclose the pressure washer nozzle 304, the O-ring 306, and the nozzle regulator 308. FIG. 3C shows a pressure washing spray output by the pressure washing lance 300 as adjusted to produce a narrow output spray. FIG. 3D shows a pressure washing spray output by the pressure washing lance 300 as adjusted to produce a wide output spray. It will be apparent to those of skill in the art the inclusion of two types of output sprays is only illustrative and that embodiments of the pressure washing lance 300 may be adjustable to produce a different number of spray patterns (e.g., three, four, five, six, etc.).

In some embodiments, the pressure washer nozzle 304 is configured to output water at a flow rate of about 5 liters per minute (e.g., 5 liters per minute, or between 4.75 liters per minute and 5.25 liters per minute, or between 4.5 liters per minute and 5.5 liters per minute, or between 4.25 liters per minute and 5.75 liters per minute, or between 4 liters per minute and 6 liters per minute, or between 3.75 liters per minute and 6.25 liters per minute, or between 3.5 liters per minute and 6.5 liters per minute). In some embodiments, the pressure washer nozzle 304 is configured to output water at a working pressure of about 800 psi (e.g., 800 psi, or between 775 psi and 825 psi, or between 750 psi and 850 psi, or between 725 psi and 875 psi, or between 700 psi and 900 psi, or between 675 psi and 925 psi, or between 650 psi and 950 psi).

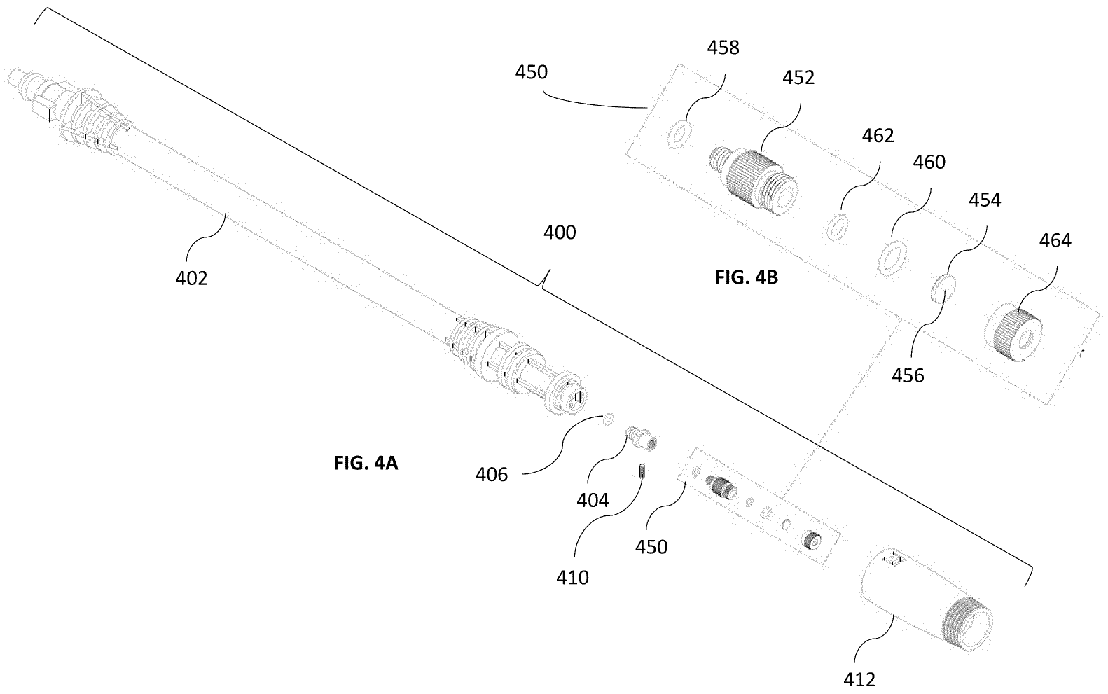

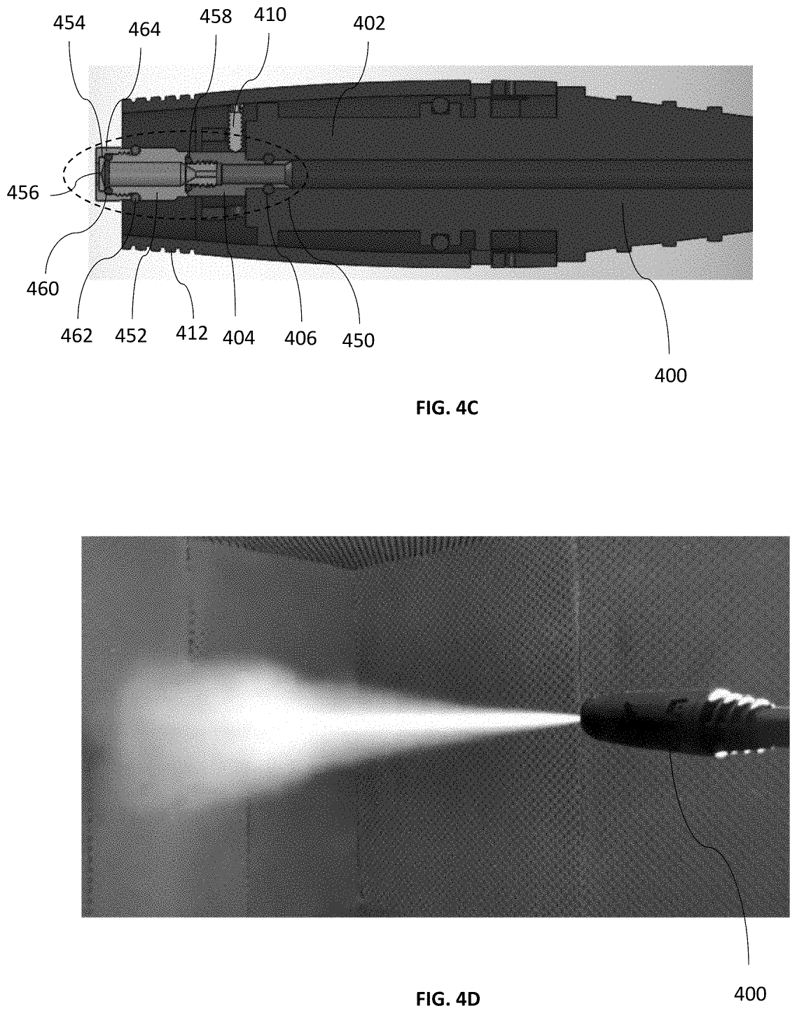

FIG. 4A shows an exploded view of an exemplary misting lance 400, FIG. 4B shows a magnified exploded view of certain elements of the misting lance 400, and FIG. 4C shows a section view of a head portion of the assembled misting lance 400. In some embodiments, the misting lance 400 includes a connector portion 402 that is configured to be coupled to the connecting rod or component 222 described above. In some embodiments, the misting lance 400 includes a misting nozzle 450 that is sized and shaped to output a supply of water provided along the connector portion 402 in a manner that is appropriate for misting. In some embodiments, the misting nozzle 450 is sized and shaped to output water at a droplet size that is in the range of from 20 to 40 microns. In some embodiments, the misting nozzle 450 is sized and shaped to output water at a flow rate of about 450 milliliters per minute (e.g., 450 milliliters per minute, or from 425 to 475 milliliters per minute, or from 400 to 500 milliliters per minute, or from 375 to 525 milliliters per minute, or from 350 to 550 milliliters per minute). In some embodiments, the misting nozzle 450 is sized and shaped to output water at a working pressure that is from 700 to 1,500 psi. In some embodiments, the output of the misting lance 400 is suitable for use at medium to large distances, such as in outdoor settings such as the exterior of buildings, warehouses, etc. In some embodiments, the misting lance 400 includes a nozzle support 404 that is configured to connect the misting nozzle 450 to the connector portion 402 and to support the misting nozzle 450. In some embodiments, the misting lance 400 includes an O-ring 406 providing sealing between the connector portion 402 and the nozzle support 404. In some embodiments, the misting lance 400 includes a set screw 410 that retains the nozzle support 404 in its place. In some embodiments, the misting lance 400 includes a lance cover 412 that is configured to connect to the connector portion 402 and to enclose the misting nozzle 450, the nozzle support 404, and the O-ring 406.

Referring now to FIG. 4B, a detailed view of elements of the misting nozzle 450 is shown. In some embodiments, the misting nozzle 450 includes a nozzle body 452 that attaches to the nozzle support 404 and contains the remaining elements of the misting nozzle 450. In some embodiments, the misting nozzle 450 includes a nozzle lid 454 that is positioned over the nozzle body 452 and includes a hole 456 through which water passes to produce mist. In some embodiments, the hole 456 is sized and shaped so as to allow water to pass therethrough so as to produce mist that travels a sufficient distance (e.g., at least 1 meter) to allow the mist to applied to a target at a sufficient range, while limiting the flow rate of the water (e.g., less than about 170 mL per minute) so as to allow the self-contained pressure washer 200 (e.g., which has an integrated water tank of finite capacity rather than being coupled to an external water supply) to produce mist for a sufficient duration. In some embodiments, the hole 456 has a diameter of 0.4 mm. In some embodiments, the hole 456 has a diameter of from 0.39 mm to 0.41 mm. In some embodiments, the hole 456 has a diameter of from 0.38 mm to 0.42 mm. In some embodiments, the hole 456 has a diameter of from 0.37 mm to 0.43 mm. In some embodiments, the hole 456 has a diameter of from 0.36 mm to 0.44 mm. In some embodiments, the hole 456 has a diameter of from 0.35 mm to 0.45 mm. In some embodiments, the misting nozzle 450 includes O-rings 458 and 460 positioned to either side of the nozzle body 452 to prevent leaks within the misting nozzle 450. In some embodiments, the misting nozzle 450 includes an identification O-ring 462 that is color-coded to identify the misting nozzle 450. In some embodiments, the misting nozzle 450 includes a nozzle cap 464 that attaches to the nozzle body 452 to retain the nozzle lid 454, the O-ring 460, and the identification O-ring 462 therebetween.

In some embodiments, the motor/pump 245 provides sufficient pressure to the water flowing to the misting nozzle 450 such that the misting nozzle 450 generates a mist output solely based on the pressurization of the water, e.g., without the use of an external air source such as a source of pressurized air. FIG. 4D shows a misting spray output by the misting lance 400.

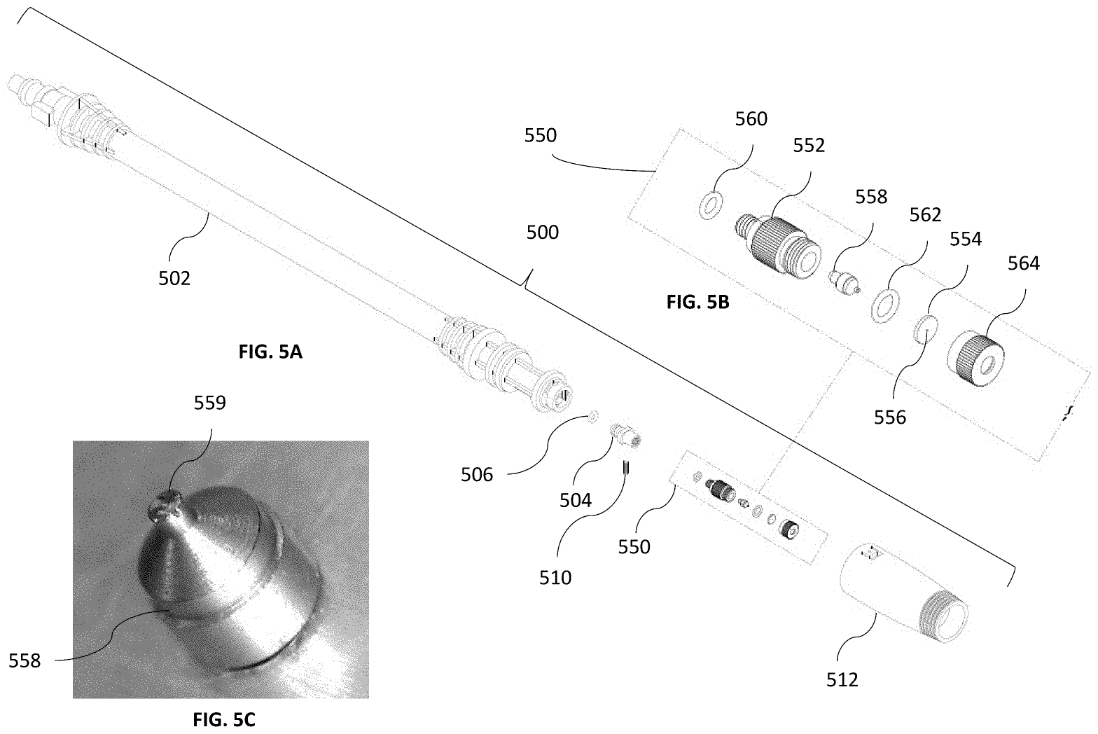

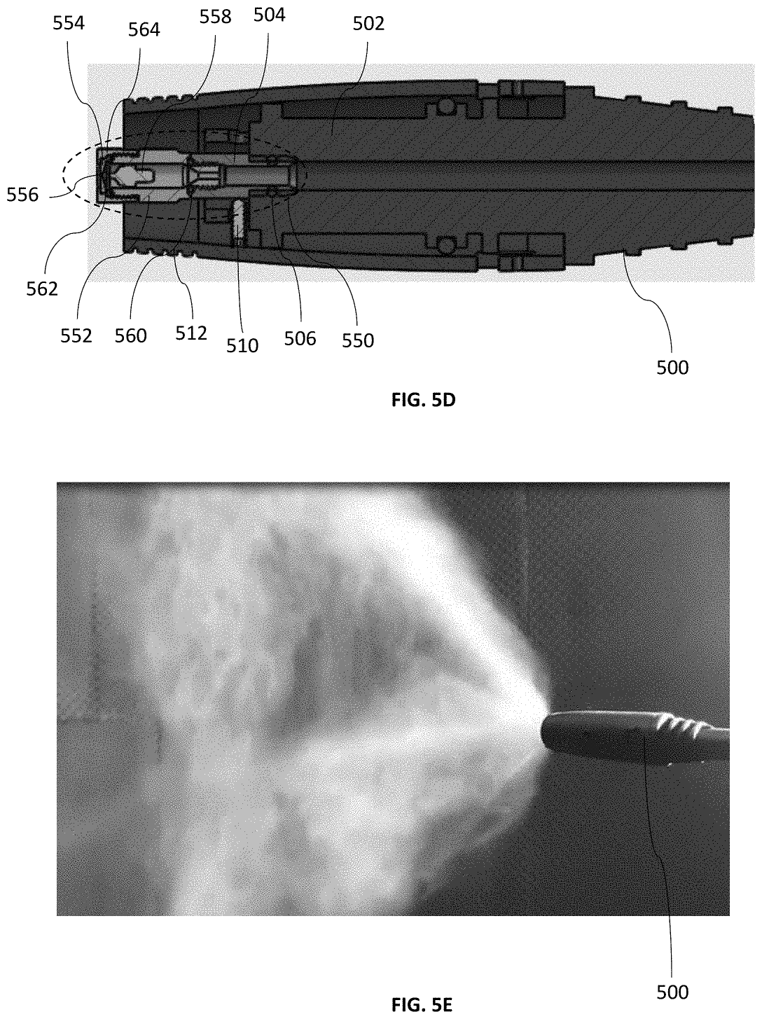

FIG. 5A shows an exploded view of an exemplary fog lance 500, FIG. 5B shows a magnified exploded view of certain elements of the fog lance 500, and FIG. 5D shows a section view of a head portion of the assembled fog lance 500. In some embodiments, the fog lance 500 includes a connector portion 502 that is configured to be coupled to the connecting rod or component 222 described above. In some embodiments, the fog lance 500 includes a fog nozzle 550 that is sized and shaped to output a supply of water provided along the connector portion 502 in a manner that is appropriate for fogging. In some embodiments, the fog nozzle 550 is sized and shaped to output water having an average droplet size of about 20 microns (e.g., from 19 microns to 21 microns, or from 18 microns to 22 microns, or from 17 microns to 23 microns, or from 16 microns to 24 microns, or from 15 microns to 25 microns, or from 14 microns to 26 microns, or from 13 microns to 27 microns, or from 12 microns to 28 microns, or from 11 microns to 29 microns, or from 10 microns to 30 microns). In some embodiments, the fog nozzle 550 is sized and shaped to output water at a flow rate of less than 170 milliliters per minute (e.g., about 170 milliliters per minute, or about 165 milliliters per minute, or about 160 milliliters per minute, or about 155 milliliters per minute, or about 150 milliliters per minute, or about 145 milliliters per minute, or about 140 milliliters per minute, or about 135 milliliters per minute, or about 130 milliliters per minute, or about 125 milliliters per minute, or about 120 milliliters per minute, or about 115 milliliters per minute, or about 110 milliliters per minute, or about 105 milliliters per minute, or about 100 milliliters per minute). In some embodiments, the fog nozzle 550 is sized and shaped to output water at a working pressure that is from 500 to 1,500 psi. In some embodiments, the output of the fog lance 500 is suitable for use at short to medium distances, such as in indoor settings such as offices, schools, etc. In some embodiments, the bottles or containers 260 contain a disinfectant and the pressure washer 200 including the fog lance 500 is suitable for use as a self-contained sanitizing machine. In some embodiments, the fog lance 500 includes a nozzle support 504 that is configured to connect the fog nozzle 550 to the connector portion 502 and to support the fog nozzle 550. In some embodiments, the fog lance 500 includes an O-ring 506 providing sealing between the connector portion 502 and the nozzle support 504. In some embodiments, the fog lance 500 includes a set screw 510 that retains the nozzle support 504 in its place. In some embodiments, the fog lance 500 includes a lance cover 512 that is configured to connect to the connector portion 502 and to enclose the fog nozzle 550, the nozzle support 504, and the O-ring 506.

Referring now to FIG. 5B, a detailed view of elements of the fog nozzle 550 is shown. In some embodiments, the fog nozzle 550 includes a nozzle body 552 that attaches to the nozzle support 504 and contains the remaining elements of the fog nozzle 550. In some embodiments, the fog nozzle 550 includes a nozzle lid 554 that is positioned over the nozzle body 552 and includes a hole 556 through which water passes to produce fog. In some embodiments, the fog nozzle 550 includes a fog piston 558. In some embodiments, the fog piston 558 includes curved cuts 559 that are sized and shaped to cause water passing therethrough to form a cyclone. FIG. 5C shows a magnified view of an exemplary fog piston 558 including the curved cuts 559. In some embodiments, the hole 556 is sized and shaped such that the passage of water therethrough, having first passed through the curved cuts of the fog piston 558, produces mist that travels a sufficient distance (e.g., less than one meter) to allow the fog to applied to a target, while limiting the flow rate of the water (e.g., less than about 170 mL per minute) so as to allow the self-contained pressure washer 200 (e.g., which has an integrated water tank of finite capacity rather than being coupled to an external water supply) to produce fog for a sufficient duration. In some embodiments, the hole 556 has a diameter of 0.4 mm. In some embodiments, the hole 556 has a diameter of from 0.39 mm to 0.41 mm. In some embodiments, the hole 556 has a diameter of from 0.38 mm to 0.42 mm. In some embodiments, the hole 556 has a diameter of from 0.37 mm to 0.43 mm. In some embodiments, the hole 556 has a diameter of from 0.36 mm to 0.44 mm. In some embodiments, the hole 556 has a diameter of from 0.35 mm to 0.45 mm. In some embodiments, the misting nozzle 550 includes O-rings 560 and 562 positioned to either side of the nozzle body 552 to prevent leaks within the fog nozzle 550. In some embodiments, the fog nozzle 550 includes a nozzle cap 564 that attaches to the nozzle body 552 to retain the nozzle lid 554, the O-ring 562, and the fog piston 558 therebetween.

In some embodiments, the motor/pump 245 provides sufficient pressure to the water flowing to the fog nozzle 550 such that the fog nozzle 550 generates a fog output solely based on the pressurization of the water, e.g., without the use of an external air source such as a source of pressurized air. FIG. 5E shows a fog output by the fog lance 500.

Test Results

Testing was conducted to identify a suitable combination of a motor/pump and a misting lance so as to provide acceptable misting performance. The testing evaluated the performance of eight different misting lances, each of which had a with a differently sized outlet hole from the other misting lances. Each misting lance was tested with two different motor/pumps having different electrical current ratings, and thereby different electrical power, from one another, resulting in sixteen test samples. Combinations of motor/pump and nozzle were evaluated to determine whether they would provide (1) mist reaching to at least 1 meter from the nozzle in order to provide sufficient range, and (2) a maximum flow rate of 170 milliliters per minute in order to provide a sufficiently long duration of use (e.g., at least three hours of use based on a self-contained water supply of 8 gallons). The table below summarizes the test results:

| Test | | | Motor/Pump A | Motor/Pump B |
|---|---|---|---|---|
| Nozzle | Hole Size | | 7 A/400-500 psi | 9 A/500-1500 psi |
| A | 0.1 | mm | Nozzle does not mist | Mist distance 0.4 m |
| | | | | Flow rate 0.015 L/min |
| B | 0.15 | mm | Nozzle does not mist | Mist distance 0.5 m |
| | | | | Flow rate 0.025 L/min |
| C | 0.2 | mm | Nozzle does not mist | Mist distance 0.7 m |
| | | | | Flow rate 0.04 L/min |
| D | 0.3 | mm | Nozzle does not mist | Mist distance 0.75 m |
| | | | | Flow rate 0.1 L/min |
| E | 0.4 | mm | Nozzle does not mist | Mist distance 1.1 m |
| | | | | Flow rate 0.15 L/min |
| F | 0.5 | mm | Nozzle does not mist | Mist distance 1.5 m |
| | | | | Flow rate 0.18 L/min |
| G | 0.6 | mm | Nozzle does not mist | Mist distance 1.8 m |
| | | | | Flow rate 0.2 L/min |
| H | 0.8 | mm | Nozzle does not mist | Mist distance 2.0 m |
| | | | | Flow rate 0.35 L/min |

Based on the above, it may be seen that only test nozzle E, having a hole size of 0.4 mm, provides suitable performance for use in a misting lance of a self-contained pressure washer (i.e., produces mist at a sufficient distance while consuming a sufficiently low flow rate of water to be used for a sufficient duration).

In an embodiment, a pressure washer includes a tank configured to contain a volume of water, the tank having an opening therein for provision of water into the tank; a first filter disposed within the opening for filtering of water being provided into the tank for providing a first level of filtration to water associated with the tank; a second filter for providing a second level of filtration to water associated with the tank; a pump for pressurizing at least a portion of the volume of water from the tank; and a spray device, in communication with the pump, for outputting the pressurized portion of the volume of water.

In an embodiment, a method for providing a pressurized fluid includes providing a tank configured to contain a volume of water, the tank having an opening therein for provision of water into the tank; providing a first filter disposed within the opening for filtering of water being provided into the tank for providing a first level of filtration to water associated with the tank; providing a second filter for providing a second level of filtration to water associated with the tank; providing a pump for pressurizing at least a portion of the volume of water from the tank; providing a spray device, in communication with the pump, for outputting the pressurized portion of the volume of water; receiving water into the tank; filtering at least a portion of the water using the first filter and the second filter; pressurizing at least a portion of the water using the pump; and outputting the pressurized water using the spray device.

In some embodiments, a self-contained pressure washer is capable of water provision via a fluid tank and/or a connected exterior fluid source. In some embodiments, the pressure washer includes a motor/pump for pressurizing fluid received from the fluid tank and providing such pressurized fluid to a spray device. In some embodiments, the spray device is configured to accept multiple accessories and/or attachments. In some embodiments, the pressure washer includes a filtration system, such as a 2-step filtration system, to ensure cleanliness of the fluid used by the pressure washer. In some embodiments, the pressure washer is manufactured of lightweight materials. In some embodiments, the pressure washer includes plug-and-play and/or modular construction. In some embodiments, the pressure washer includes locomotion elements for convenient mobility.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

For example, certain features, though not all features discussed and/or illustrated in FIGS. 1A-2 may be present or used for a particular pressure washing method, system, and/or apparatus. Additional and/or alternative features may also be present or used for a particular pressure washing method, system, and/or apparatus.

What is claimed is:

1. A device, comprising:
a tank sized and shaped to contain a quantity of water,
wherein the quantity of water is between 4 gallons and 12 gallons;
a pump in fluid communication with the tank,
wherein the pump is configured to extract water from the tank and to pressurize
the water extracted from the tank to a pressure that is from 500 psi to 1500 psi,
wherein the pump has an electrical current of between 8 A and 10 A and a power of between 960 W and 1200 W;
a connector having a first end and a second end,
wherein the first end of the connector is in fluid communication with the tank and is coupled to the tank so as to receive pressurized water produced by the tank and convey the pressurized water through the connector from the first end to the second end; and
a plurality of lances configured to be interchangeably coupled to the second end of the connector so as to receive the pressurized water from the second end of the connector and to expel the water,
wherein the plurality of lances includes a first lance that is a fog lance,
wherein the fog lance has a fog nozzle,
wherein the fog nozzle includes a fog nozzle lid having an aperture having a size that is from 0.35 mm to 0.45 mm,
wherein the fog nozzle includes a fog piston configured to cause rotational movement of water passing therethrough,
wherein the fog nozzle is configured to produce a fog nozzle flow rate that is less than 0.17 liters per minute, and
wherein the fog nozzle is configured to produce a fog output that travels at least 1 meter from the fog nozzle.

2. The device of claim 1, wherein the tank is sufficiently sized such that the quantity of water is a sufficient quantity of water to allow for continuous use at the fog nozzle flow rate for a duration of at least three hours.

3. The device of claim 1, wherein the fog nozzle is configured to produce a fog output having an average droplet size of about 20 microns.

4. The device of claim 1, further comprising a battery.

5. The device of claim 1, further comprising a power cable configured to be coupled to an external power source.

6. The device of claim 1, further comprising one or more wheels configured to allow the device to be rolled.

7. The device of claim 1, further comprising:
a container,
wherein the container is configured to hold a cleaning product,
wherein the container is positioned in fluid communication with the tank and the connector between the tank and the first end of the connector, and
wherein the container is configured such that the cleaning product mixes with water passing from the tank to the connector.

8. The device of claim 7, wherein the cleaning product is a disinfectant.

9. The device of claim 1, wherein the pump and the fog nozzle cooperate to produce the fog output without a supply of pressurized air.

10. The device of claim 1, wherein the plurality of lances includes a second lance that is a pressure washing lance.

11. The device of claim 10, wherein the pressure washing lance is configured to output water at a flow rate of about 5 liters per minute.

12. The device of claim 10, wherein the pressure washing lance is configured to output water at a working pressure of about 800 psi.

13. The device of claim 10, wherein the pressure washing lance includes a nozzle regulator that is operable by a user to adjust a spray pattern of water output by the pressure washing lance.

14. The device of claim 1, wherein the plurality of lances includes a second lance that is a misting lance.

15. The device of claim 14, wherein the misting lance has a misting nozzle,
wherein the misting nozzle includes a misting nozzle lid having an aperture having a size that is from 0.35 mm to 0.45 mm,
wherein the misting nozzle is configured to produce a misting nozzle flow rate that is greater than 0.17 liters per minute, and
wherein the misting nozzle is configured to produce a mist output that travels at least 1 meter from the misting nozzle.

16. The device of claim 15, wherein the misting nozzle is configured to produce a misting nozzle flow rate that is about 450 milliliters per minute.

17. The device of claim 15, wherein the misting nozzle is configured to produce a mist output having an average droplet size that is in a range of from 20 to 40 microns.
